(19) United States
(12) Patent Application Publication
(10) Pub. No.: US 2014/0019253 A1
(43) Pub. Date: Jan. 16, 2014

(54) SYSTEMS AND METHODS FOR SELECTING AND DISPLAYING INTERACTIVE ADVERTISING CONTENT WITH A LOCK SCREEN

(71) Applicant: Richard Ricasata, San Diego, CA (US)

(72) Inventor: Richard Ricasata, San Diego, CA (US)

(21) Appl. No.: 13/545,781

(22) Filed: Jul. 10, 2012

(51) Int. Cl. G06Q 30/02

(52) U.S. Cl. 705/14.64; 705/14.66

(57) ABSTRACT

Systems and methods are provided for selecting and displaying interactive advertising content on a lock screen or splash screen of a touch-sensitive portable electronic device. A lock screen is provided with at least one interactive advertisement where a user can select one or more options relating to the advertisement, scroll through numerous different advertisements, or unlock the portable electronic device. The splash screen is provided with at least one interactive advertisement for display when the portable electronic device is loading an application or transitioning from one device setting to another. The interactive advertising content may be selected by a remote advertisement selection server based on user data collected from the portable electronic device, such as the location of the user, content from social media applications, search queries and other information about the user that is available on the portable electronic device.

### BACKGROUND

1. Technical Field

The embodiments described herein are related to selecting and displaying interactive advertising content on a touch-sensitive device during a lock screen function, and more specifically to selecting interactive advertising content based on user data obtained from a portable electronic device and displaying the advertising content on a touch-sensitive display screen of the device for interaction with the user during a lock screen function.

2. Related Art

A lock screen is a type of graphical user interface (GUI) that is displayed on a touch-sensitive display screen of a portable electronic device when the display screen is “locked,” or programmed not to respond to most touches on the display screen. When the portable electronic device is not being used by a user, the touch-sensitive display screen may be locked so that inadvertent touches on the touch-sensitive display screen will not accidentally perform a function on the portable electronic device.

The lock screen may provide some visual indication to the user of the portable electronic device that the screen is locked, such as a word, symbol, image or other visual cue. FIG. 1A illustrates one embodiment of a lock screen 102 on a touch-sensitive display screen 104 of a smartphone 100, as is known in the art. The primary feature of the lock screen 102 is that when a user touches the display screen, the smartphone 100 takes no action unless a specific sequence or series of touches are performed that will “unlock” the smartphone 100 and cause the lock screen 102 to disappear. In FIG. 1, the lock screen 102 includes a “slide-to-unlock” button 106, as is known in the art, which requires the user to touch the arrow 108 on the display screen 104 and drag the arrow 108 to the right. FIG. 1B illustrates another type of lock screen 102 with a plurality of circles 110 which represent stopping points where an operating system of the smartphone 100 is configured to recognize a user's gesture or touch across different areas of the display screen 104. The user can therefore perform a gesture or series of touches across any portion of the display screen 104 in order to unlock the smartphone 100. The lock screen may also provide a visual indication of how to “unlock” the display screen so that the user can interact with the touch-sensitive display screen of the portable electronic device. The display screen may provide visual indications for a gesture which the user can execute on the touch-sensitive display screen, or a keypad where the user can depress a sequence of keys to unlock the display screen.

The lock screen on a portable electronic device provides only the visual indication that the touch-sensitive display screen is locked and how to unlock the display screen. The user will view the lock screen numerous times during a given day, as the lock screen is displayed each time the user wants to use the portable electronic device. The lock screen is usually devoid of content that interests the user, as it is provided simply for its functional use of informing the user of the locked state of the display screen and the method needed to unlock the screen.

A splash screen is a type of GUI that is displayed on a display of an electronic device when the device is performing a task where user input is unnecessary or unwanted. For example, a splash screen is often displayed when a program or application on an electronic device, such as a computer, is being loaded. The splash screen may also be displayed on a portable electronic device, such as a mobile phone or tablet, during a transition between one device setting and another device setting. For example, the splash screen may be displayed on a portable electronic device when a user performs an “unlock” gesture or touch sequence on a touch-sensitive display screen before a standard GUI home screen of the portable electronic device is displayed.

The splash screen is typically an image, word or symbol that is visually appealing to the user, or which provides an image, word or symbol representative of the program or application that is being loaded. The splash screen may also include a status bar, which shows an indication of how much of the program has been loaded or how much longer the electronic device will need before the program is completely loaded and ready for use by the user.

However, as with the lock screen, there is little or no actual content on the splash screen, as the splash screen displays a symbol, word, image or status bar, none of which are particularly interesting to a user. Furthermore, the user is unable to interact with the electronic device when a splash screen is being displayed, which often frustrates the user while waiting for an application to load.

What is needed is content which will keep the user interested in the portable electronic device during a lock screen function or during a splash screen function.

### SUMMARY

Embodiments described herein provide for systems and methods for selecting and displaying interactive advertising content on a lock screen or splash screen on a touch-sensitive display screen of a portable electronic device. The interactive advertising content allows a user to interact with the portable electronic device when the device is otherwise locked or unable to be fully accessed, which keeps the user attendant on the portable electronic device and viewing any content displayed therein.

In one embodiment, a method of selecting and displaying advertising content on a lock screen of a touch-sensitive device comprises: transmitting a plurality of user data from a portable electronic device to an advertisement-selecting server; selecting at least one advertisement at the advertisement-generating server based on the plurality of user data; transmitting the at least one selected advertisement from the advertisement-generating server to the portable electronic device; and displaying the at least one advertisement on a touch-sensitive display screen of the portable electronic device when a lock screen function is activated.

In another embodiment, a system of selecting and displaying advertising content on a lock screen of a touch-sensitive device comprises: a user data collection unit which collects a plurality of user data from the portable electronic device; an advertisement-selecting server which receives the user data and selects at least one advertisement based on the plurality of user data; an advertisement display unit on the portable electronic device which receives the at least one selected advertisement and displays the at least one selected advertisement on a touch-sensitive display of the portable electronic device when a lock screen function on the portable electronic device is activated.

In a further embodiment, a method of selecting and displaying interactive advertising content on a splash screen on a portable electronic device comprises: transmitting a plurality of user data from a portable electronic device to an advertisement-selecting server; selecting at least one advertisement at the advertisement-generating server based on the plurality of user data; transmitting the at least one selected advertisement from the advertisement-generating server to the portable electronic device; and displaying the at least one advertisement on a touch-sensitive display screen of the portable electronic device when a splash screen function is activated.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

The various embodiments provided herein are described in detail with reference to the following figures. The drawings are provided for purposes of illustration only and merely depict typical or example embodiments. These drawings are provided to facilitate the reader's understanding of the invention and shall not be considered limiting of the breadth, scope, or applicability of the embodiments. It should be noted that for clarity and ease of illustration these drawings are not necessarily made to scale.

FIGS. 1A and 1B are illustrations of a lock screen as known in the art.

FIG. 2 is an illustration of a first interactive advertisement being displayed as a lock screen on a touch-sensitive display screen of a portable electronic device, according to one embodiment of the invention.

FIG. 3 is another illustration of a second interactive advertisement being displayed as a lock screen on the touch-sensitive display screen of the portable electronic device, according to one embodiment of the invention.

FIG. 4 illustrates the ability to scroll between the first interactive advertisement and second interactive advertisement on the lock screen, according to one embodiment of the invention.

FIG. 5 illustrates a list of menu options available on the first interactive advertisement, according to one embodiment of the invention.

FIG. 6 is an illustration of a home screen of the portable electronic device once the device has been unlocked, according to one embodiment of the invention.

FIG. 7 is a block diagram which illustrates a system for selecting and displaying interactive advertising content on a portable electronic device, according to one embodiment of the invention.

FIG. 8 is flowchart illustrating a method of selecting and displaying advertising content on the lock screen of the portable electronic device, according to one embodiment of the invention.

FIG. 9 is a block diagram illustrating user data which is used to generate advertising content on the lock screen and analytical data obtained from interaction by the user with the advertising content on the lock screen, according to one embodiment of the invention.

FIG. 10 is a block diagram of functional elements of a computer system that can be used to implement the mobile device and/or the servers described in the systems and methods disclosed herein.

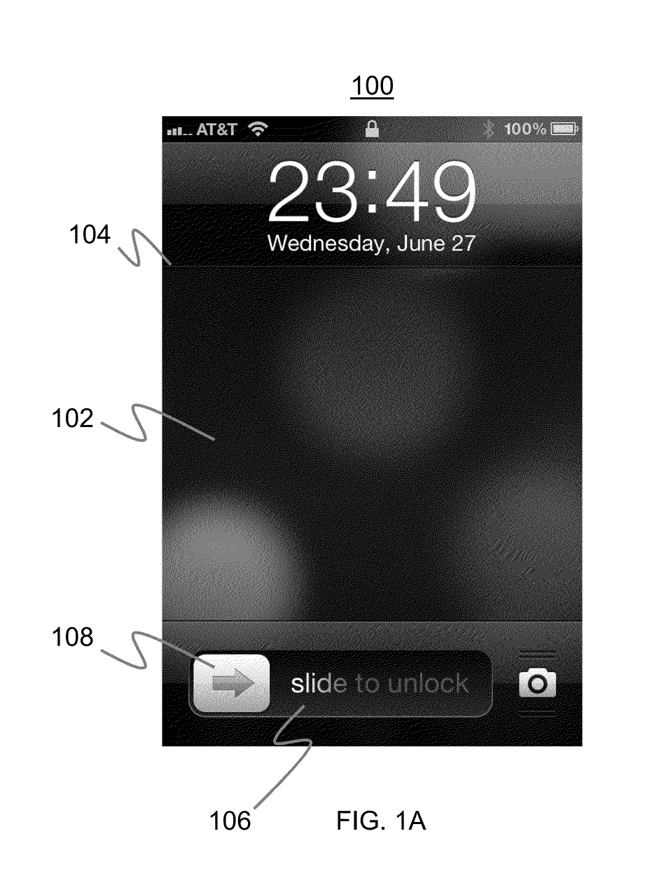

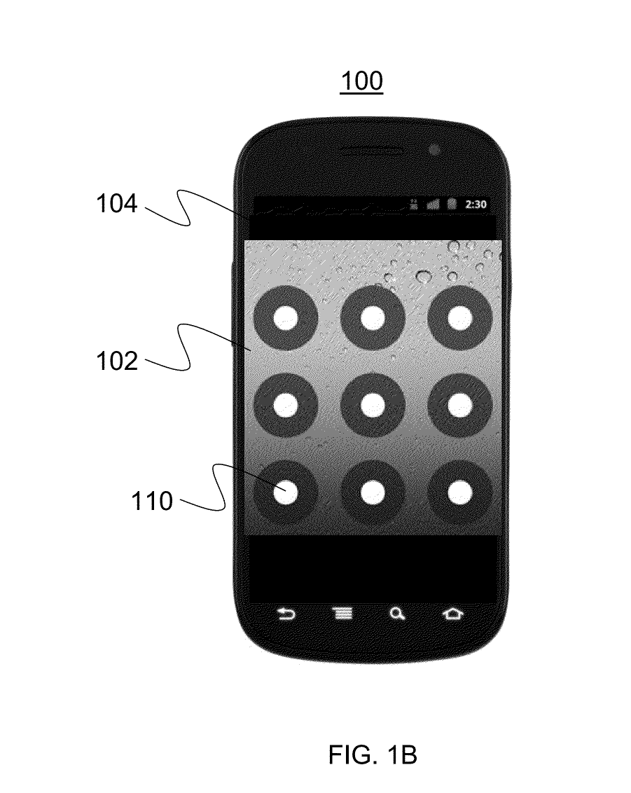

### DETAILED DESCRIPTION

The embodiments described herein provide for systems and methods for selecting and displaying advertising content on a lock screen or splash screen of a touch-sensitive portable electronic device. A lock screen is provided with at least one interactive advertisement (ad) where a user can select one or more options relating to the ad, scroll through numerous different ads, or unlock the portable electronic device. The splash screen is provided with at least one interactive ad for display when the portable electronic device is loading an application or transitioning from one device setting to another. The interactive advertising content may be selected by a remote advertisement selection server based on user data collected from the portable electronic device, such as the location of the user, content from social media applications, search queries and other information about the user that is available on the portable electronic device.

The portable electronic device may be any portable device with a touch-sensitive display or touch-sensitive input device, such as a mobile phone, smartphone, tablet or laptop computer. In one embodiment, a non-portable device may be implemented with the lock screen, including a general purpose computer such as a desktop or server platform with an attached touchscreen display device. Additionally, the portable electronic device may not have a touchscreen and may instead provide a projection of a user interface and be configured to recognize gestures made by a user in space and detected by motion or position sensors. Instead of a touchscreen, a device may implement a pair of glasses worn by the user which display the UI, and the user may use gestures in open space, voice recognition or with their eyes to unlock the screen. A lock screen function on the portable electronic device may be a software application running on the device, and it may be configured to communicate with one or more applications also running on the device, hardware components and sensors on the device, and even other devices connected with the portable electronic device—either wired or wirelessly.

### I. Lock Screen Advertisements

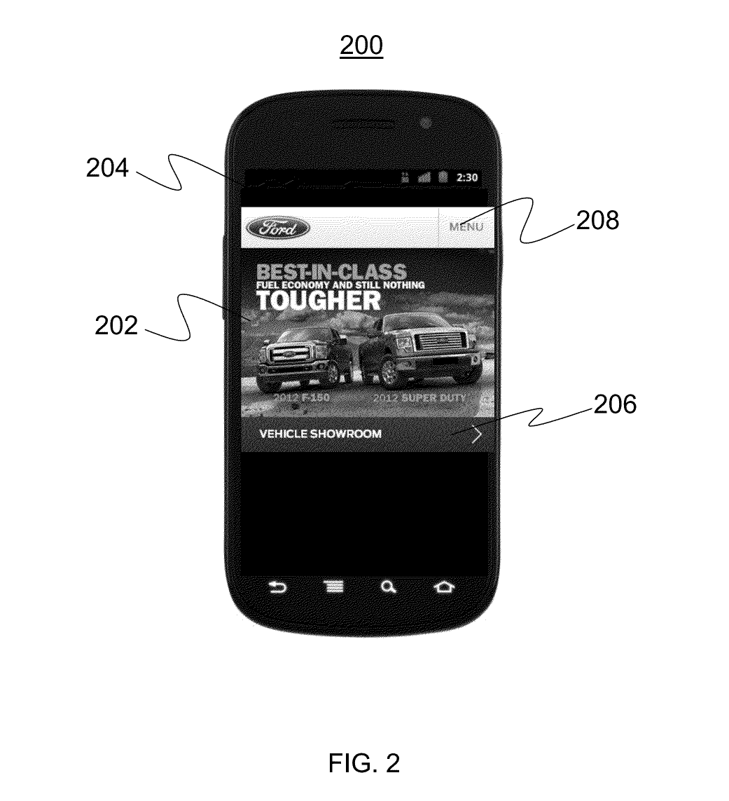

FIG. 2 is an illustration of a first advertisement (ad) lock screen 202 being displayed on a touch-sensitive display screen 204 of a smartphone 200, in accordance with one embodiment of the invention. The first ad lock screen 202 is, overall, a graphical user interface (GUI), with at least one ad provided therein. The ad may be a still image, a sequence of images or a video. The first ad lock screen 202 may include one or more hyperlinks 206 which a user can immediately select in order to launch a web browser on the smartphone 200 and view additional information from the advertiser. The first ad lock screen 202 may also include a menu button 208 which provides additional options for the user, including unlocking the phone to terminate the lock screen function, as will be described further below.

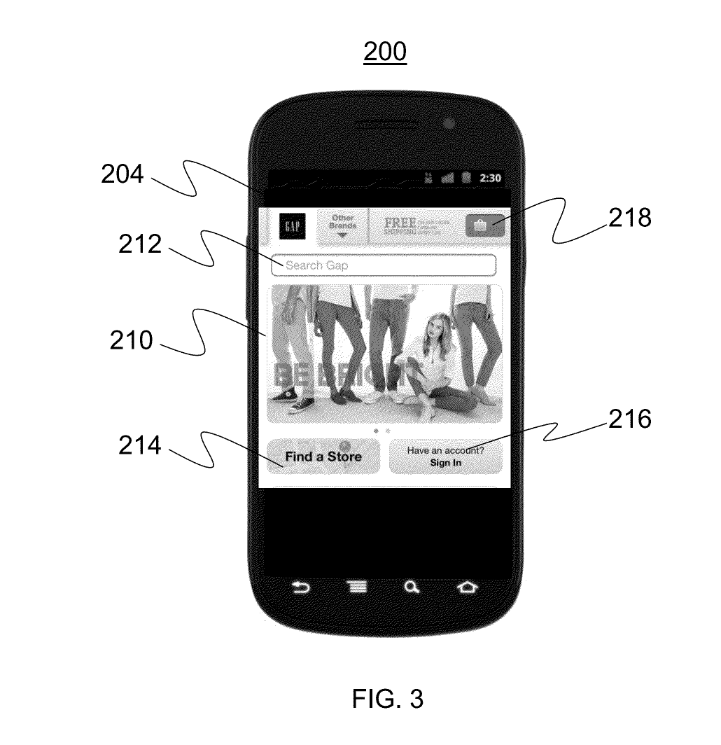

One embodiment of a second ad lock screen 210 is illustrated in FIG. 3. The second ad lock screen 210 illustrates additional features of the ad lock screen, including an ad search window 212, a store locator button 214 to help the user find a brick and mortar location of the advertiser, an account sign-in button 216 for a user to sign in to an account that the user may have with the advertiser, and a shopping cart button 218 for a user to access a list of items which they are about to purchase. In one embodiment, the second ad lock screen 210 may be created with a plug-in or program which extends the functionality of the lock screen beyond the simple menu button 208 in FIG. 2. An advertiser may create their own layout of the ad lock screen and create menu logic behind the ad that enables customized menu items (ad search window 212, store locator button 214, etc.) and other interactive functionality that may be provided in an application programming interface (API). The advertiser may then create customized menu layouts such as the second ad lock screen 210, allowing a programmer to place functionality anywhere on the screen instead of being limited to a simple menu button. The second ad lock screen 210 may work together with other applications running on the smartphone 200 in order to provide access to the Internet with a web browsing application or store location data using a map application. Data on the location of the phone may also be used for one or more features, as will be described further below.

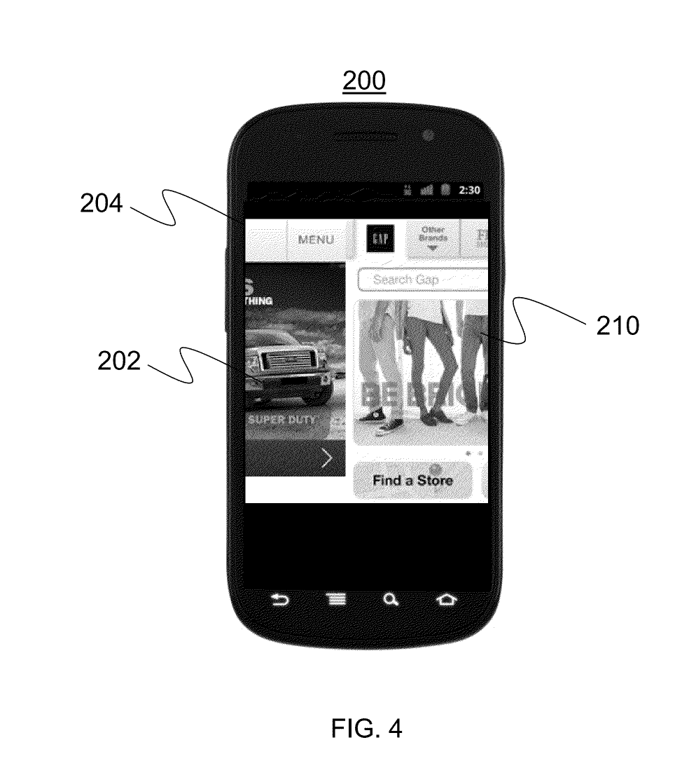

In one embodiment, a plurality of ads may be displayed during a lock screen function so that the user can scroll between different ads. As shown in FIG. 4, the user can perform a gesture on the display screen 204 to scroll from the first ad lock screen 202 to the second ad lock screen 210. In another embodiment, the user can use navigational controls on the display screen or represented as physical buttons on the smartphone. The ads may automatically scroll on their own after a certain period of time, so the user will be exposed to multiple different ads over the short period of time.

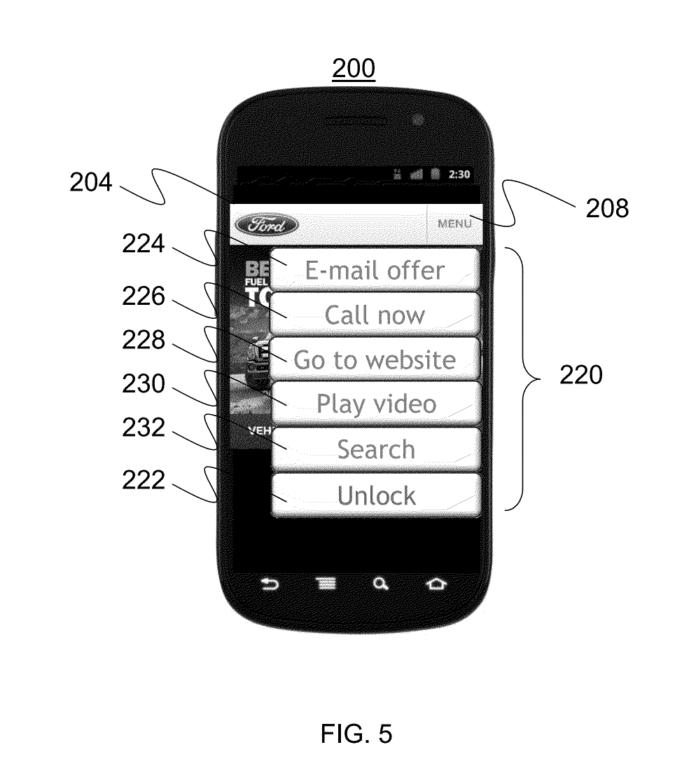

As seen in FIG. 5, a drop-down menu 220 may appear when the menu button 208 is depressed. In one embodiment, a gesture performed on the screen or another physical button on the smartphone may also activate the menu. The user may be provided with one or more options, including an Unlock button 222 which unlocks the display screen 204 and terminates the lock screen function. Other buttons include e-mailing an offer to a dealer 224 (or asking the dealer to e-mail an offer to the user), calling a store location 226, visiting a website 228, playing a video 230 and searching for related content 232. However, one of skill in the art will appreciate that any number of different features could be listed herein, and the drop down menu 220 may be customized for each ad lock screen, each smartphone 200 which runs the lock screen application, or each smartphone carrier which provides voice and data service to the mobile device.

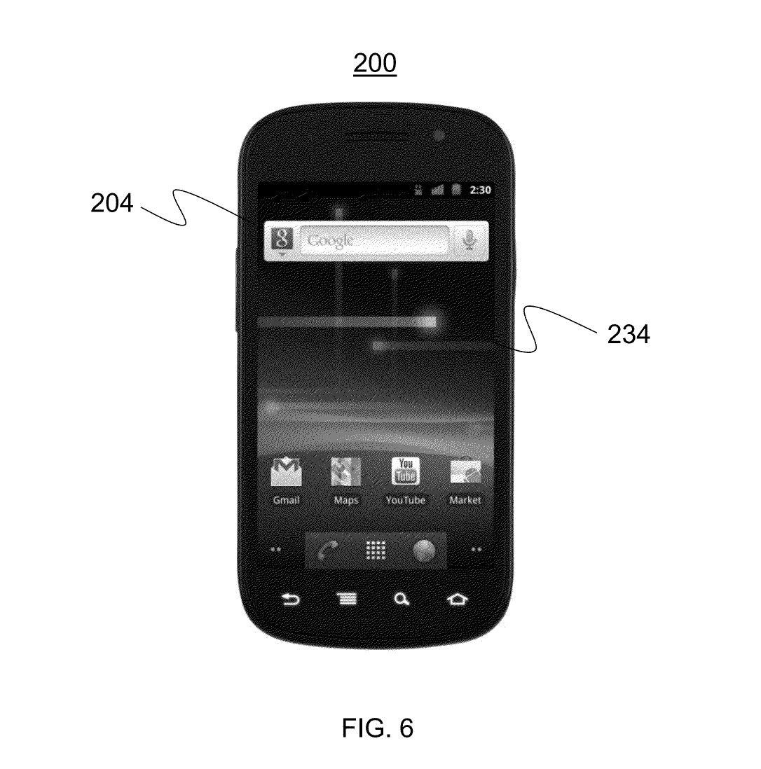

If the user chooses simply to unlock the display screen 204 with the Unlock button 222, a home screen 234 of the smartphone 200 then appears, as illustrated in FIG. 6.

### II. Splash Screen Advertisements

In one embodiment, an advertisement may be displayed as a splash screen during one of many situations when a splash screen would be displayed on the smartphone. For example, a splash screen ad could be displayed when an application on the portable electronic device is being loaded, or when the lock screen function has been deactivated and the home screen is being loaded. The splash screen ad may be provided with the same functionality as the lock screen ad, including links to a website, menu options and other customizable buttons for the user to select for each different type of ad.

### III. Collection of User Data

In one embodiment, a plurality of user data may be collected from the portable electronic device that will be used to determine one or more appropriate advertisements for the user of the portable electronic device. The user data may be any type of data captured from hardware or software on the portable electronic device, such as location data on the location of the phone captured by a global positioning system (GPS), cellular antenna or Wi-Fi network. The location data may be used to select an ad for a business nearby the user and their portable electronic device.

In another embodiment, user data from software applications on the portable electronic device may be obtained to determine profile information on the user that may be used to determine an appropriate ad. User profile data may be obtained from content obtained from social media applications, search engine requests, other search parameters, plug-ins, e-mails, favorite websites or even by identifying that a user has downloaded a particular software application. The plug-in may be a third-party application which interfaces with the lock screen. One, several or all of these types of user profile data may be used to select an appropriate ad.

In one embodiment, a link may be established between a user's account with a social media application or website, so that content which the user generates or views on the social media site is used to generate a targeted ad on the lock screen. For example, if the user posts a message on a social media website stating “Anyone want to meet up for pizza?,” the user's geo-location and the word “pizza” is sent to an ad server where an ad for a local pizza restaurant is selected for display on the lock screen. A coupon may also be displayed in the lock screen ad.

### IV. User Analytics

In one embodiment, the actions of the user are tracked in relation to the lock screen ad or splash screen ad being displayed on the portable electronic device. An application running on the portable electronic device may be configured to identify the particular ad or plurality of ads displayed, the type of media of the ad (picture, video, etc), a location of the user, an action taken by the user in relation to the ad, how many times the user views the ad, how long the user views the ad and search query data and matching. A search query match would occur when a match is found between a need or desire identified by a social media feed or an explicit search initiated by a user with that search query. All of the data collected on the interaction between the user and the ad can be tracked and sent back to a remote server for evaluating the effectiveness of the ads.

### V. System Diagram

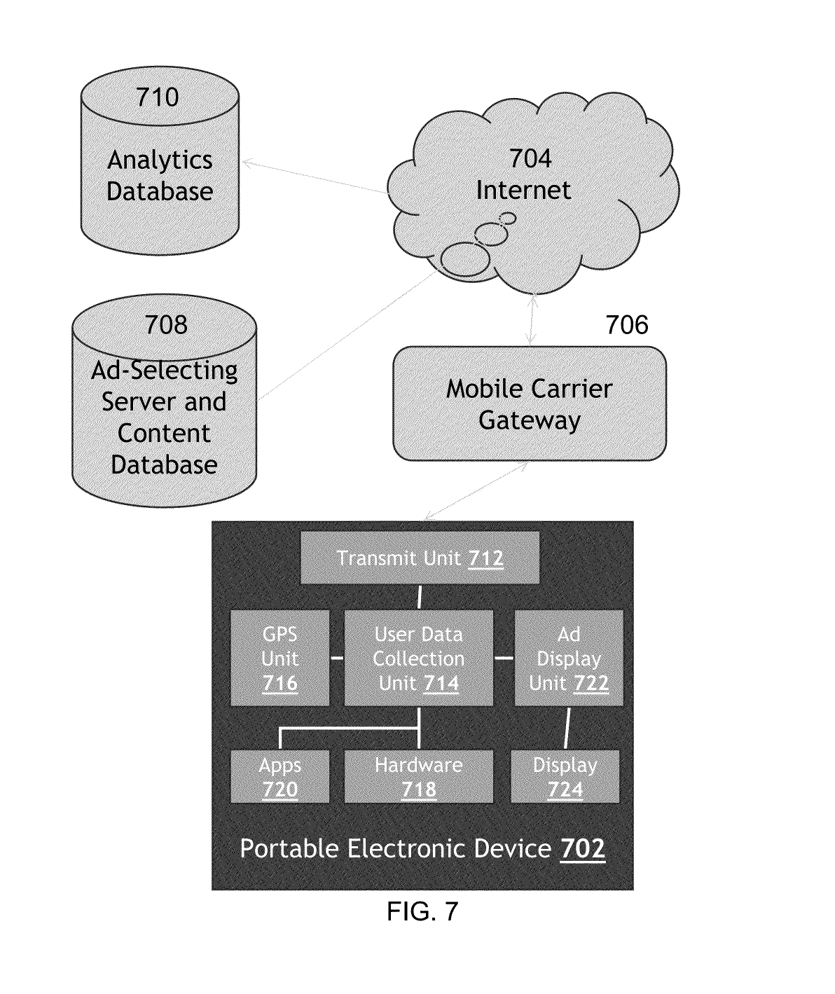

FIG. 7 is a block diagram which illustrates one embodiment of a system for selecting and displaying interactive advertising content on the portable electronic device. The portable electronic device 702 is connected to a network, such as the Internet 704, either directly or, as illustrated, through a mobile carrier gateway 706 which is operated by a mobile cellular service company providing voice and data connections to the portable electronic device. The portable electronic device 702 can then communicate over the Internet 704 with an advertisement-selecting server and a content database 708 to send user data and receive selected advertisements for displaying on the lock screen or splash screen. An analytics database 710 may be provided to receive the data collected at the portable electronic device 702 pertaining to the user's interactions with the ad, as has been previously described. In one embodiment, the analytics database 710 may also be integrated with the ad-selecting server and content database 708.

The portable electronic device 702 may be configured with a plurality of hardware and software units which execute the various aspects of the embodiments described herein. A transmitting unit 712 transmits data to and from the network, such as the Internet 704, that is connected with the portable electronic device 702. The transmitting unit 712 is responsible for transmitting user data from the portable electronic device 702 to the ad-selecting server 708 for selecting an ad, as well as the analytics data on the user's interaction with the ad on the lock screen and splash screen. A user data collection unit 714 interacts with hardware units 718 and software applications 720 on the portable electronic device 702 to collect data about the device and user profile data on the user which is then transmitted to the ad-selecting server 708. One example of a hardware unit is a GPS unit 716 which transmits location data of the portable electronic device to the user data collection unit 714 in order for the ad-selecting server 708 to generate location-based ads and ad content.

The transmitting unit 712 may also be responsible for receiving the ads selected by the ad-selecting server 708 and forwarding the ad to an ad display unit 722 for generating and displaying the ad on a touch-sensitive display 724 on the portable electronic device 702.

### VI. Methods of Ad-Selection and Display

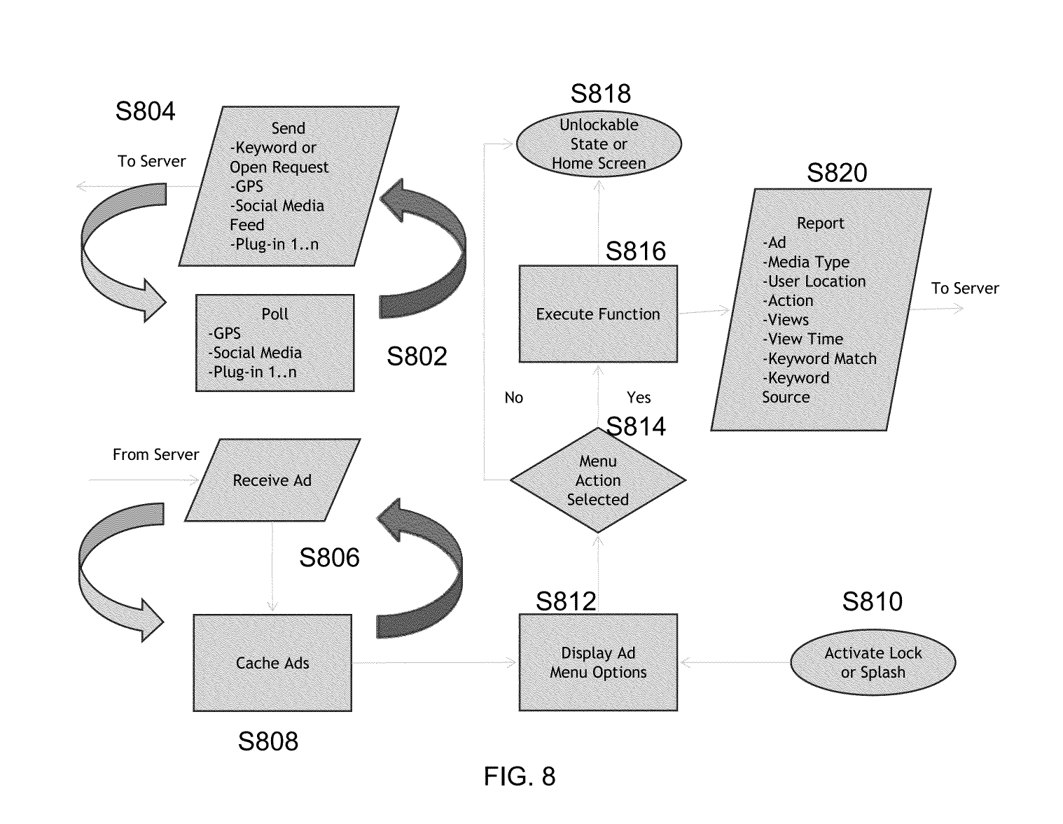

FIG. 8 illustrates one embodiment of a method of selecting and displaying interactive advertising content on a lock screen or splash screen. In a first step S802, user data is obtained at the portable electronic device by polling hardware and software units. In a second step S804, the user data is sent to the ad-selecting server, where one or more ads are selected based on the user data. In a third step S806, the ad is received back at the portable electronic device. In one embodiment, the one or more ads may be cached in local memory on the portable electronic device for future display to the user (S808). In a next step S810, the lock screen or splash screen functionality is launched, and the one or more selected ads are displayed as the lock screen or splash screen (S812). The menu options and other links are displayed along with the ads. When the user selects a menu option (S814), the selected function is executed (S816), which either initiates further activity with regard to the ad or simply unlocks the touch-sensitive display and returns the use to the home screen (S818). In a further step S820, the user's interaction with the ad is collected and reported to the analytics server for analysis.

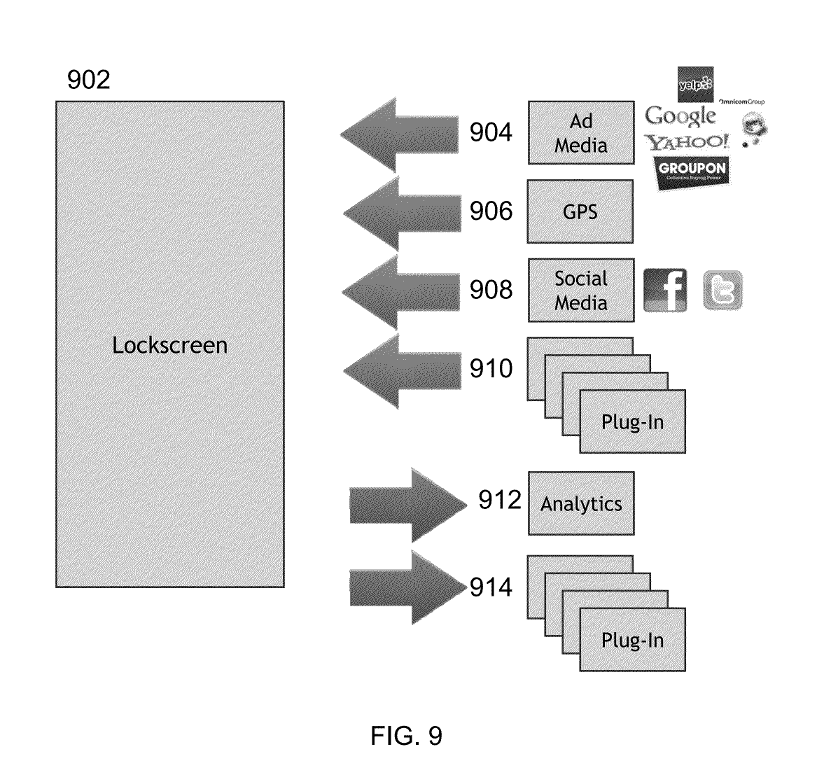

FIG. 9 is a block diagram which illustrates the use of user data in relation to a lock screen 902, in accordance with the methods described above. User data such as ad media 904, GPS location data 906, social media data 908 and plug-in data 910 are used to select one or more ads for the lock screen 902 (or splash screen). The ad media 904 pertains to the actual form of the ad on the screen—such as an image file (jpg, bmp, tif, gif, etc.), a video file (wmv, mpg, mpeg, swf, flash, etc) or an audio file (mp3, etc). This list may vary, and the type of ad media should not be limited thereto. When the one or more selected ads are displayed to the user, the user's interaction with the ad or ads is tracked, and this interaction data is then output for analytics 912 or for use with various plug-ins 914.

The plug-ins 914 may be simple applications which track user activity, such as what the user viewed, where they viewed it, what action they took after viewing it, how many views it took of the same ad before they acted on it, how they responded to the ad (email, coupon, call, forward, share, view video), etc. In one embodiment, a plug-in would be used for creating and displaying the second ad lock screen 210 in FIG. 3. The ad would be bundled with a plug-in or program that extends the functionality of the lock screen and transmitted to the smartphone. The creator of the ad can therefore create a customized layout of the second ad lock screen 210 and create appropriate menu logic behind the ad that enables the menu items and functionality described above with regard to FIG. 3, such as the ad search window 212, the store locator button 214, the account sign-in button 216 and the shopping cart button 218. The ad creator can therefore create customized functionality and layouts anywhere on the display screen.

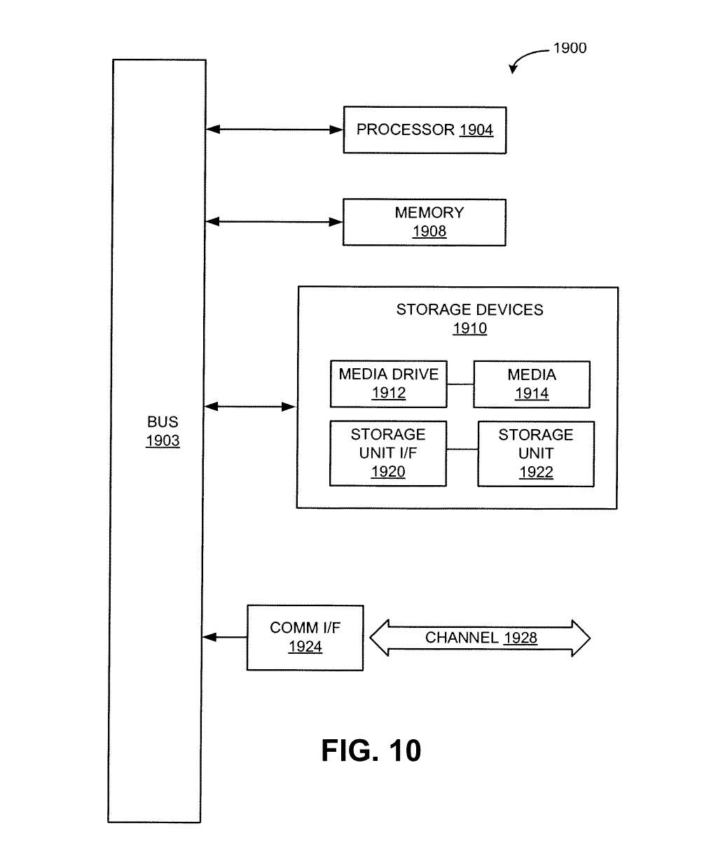

### VII. Computer-Implemented Embodiment

Where components or modules of processes used in conjunction with the operations described herein are implemented in whole or in part using software, in one embodiment, these software elements can be implemented to operate with a computing or processing module capable of carrying out the functionality described with respect thereto. One such example-computing module is shown in FIG. 10, which illustrates a computer system that can be used to implement mobile remittance server according to an embodiment.

Various embodiments are described in terms of this example-computing module 1900. After reading this description, it will become apparent to a person skilled in the relevant art how to implement the invention using other computing modules or architectures.

Referring now to FIG. 10, computing module 1900 may represent, for example, computing or processing capabilities found within desktop, laptop and notebook computers; mainframes, supercomputers, workstations or servers; or any other type of special-purpose or general-purpose computing devices as may be desirable or appropriate for a given application or environment. Computing module 1900 might also represent computing capabilities embedded within or otherwise available to a given device. For example, a computing module might be found in other electronic devices. Computing module 1900 might include, for example, one or more processors or processing devices, such as a processor 1904. Processor 1904 might be implemented using a general-purpose or special-purpose processing engine such as, for example, a microprocessor, controller, or other control logic.

Computing module 1900 might also include one or more memory modules, referred to as main memory 1908. For example, random access memory (RAM) or other dynamic memory might be used for storing information and instructions to be executed by processor 1904. Main memory 1908 might also be used for storing temporary variables or other intermediate information during execution of instructions by processor 1904. Computing module 1900 might likewise include a read only memory (“ROM”) or other static storage device coupled to bus 1902 for storing static information and instructions for processor 1904.

The computing module 1900 might also include one or more various forms of information storage mechanism 1910, which might include, for example, a media drive 1912 and a storage unit interface 1920. The media drive 1912 might include a drive or other mechanism to support fixed or removable storage media 1914. For example, a hard disk drive, a floppy disk drive, a magnetic tape drive, an optical disk drive, a CD or DVD drive (R or RW), or other removable or fixed media drive. Accordingly, storage media 1914 might include, for example, a hard disk, a floppy disk, magnetic tape, cartridge, optical disk, a CD or DVD, or other fixed or removable medium that is read by, written to or accessed by media drive 1912. As these examples illustrate, the storage media 1914 can include a computer usable storage medium having stored therein particular computer software or data.

In alternative embodiments, information storage mechanism 1910 might include other similar instrumentalities for allowing computer programs or other instructions or data to be loaded into computing module 1900. Such instrumentalities might include, for example, a fixed or removable storage unit 1922 and an interface 1920. Examples of such storage units 1922 and interfaces 1920 can include a program cartridge and cartridge interface, a removable memory (for example, a flash memory or other removable memory module) and memory slot, a PCMCIA slot and card, and other fixed or removable storage units 1922 and interfaces 1920 that allow software and data to be transferred from the storage unit 1922 to computing module 1900.

Computing module 1900 might also include a communications interface 1924. Communications interface 1924 might be used to allow software and data to be transferred between computing module 1900 and external devices. Examples of communications interface 1924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1924 might typically be carried on signals, which can be electronic, electromagnetic (which includes optical) or other signals capable of being exchanged by a given communications interface 1924. These signals might be provided to communications interface 1924 via a channel 1928. This channel 1928 might carry signals and might be implemented using a wired or wireless communication medium. These signals can deliver the software and data from memory or other storage medium in one computing system to memory or other storage medium in computing system 1900. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 1908, storage unit 1920, and media 1914. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1900 to perform features or functions of the present invention as discussed herein.

While various embodiments of the present invention have been described above, it should be understood that they have been presented by way of example only, and not of limitation. The breadth and scope of the present invention should not be limited by any of the above-described exemplary embodiments. Where this document refers to technologies that would be apparent or known to one of ordinary skill in the art, such technologies encompass those apparent or known to the skilled artisan now or at any time in the future. In addition, the invention is not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the present invention.

Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of selecting and displaying interactive advertising content on a lock screen on a portable electronic device, comprising:
transmitting a plurality of user data from a portable electronic device to an advertisement-selecting server, wherein the user data includes at least one of search query data and social media data;
selecting at least one advertisement at the advertisement-generating server based on the plurality of user data;
transmitting the at least one selected advertisement from the advertisement-generating server to the portable electronic device; and
displaying the at least one advertisement on a touch-sensitive display screen of the portable electronic device when a lock screen function is activated;
wherein the lock screen includes a menu button which is configured to display options for interacting with the lock screen.

2-4. (canceled)

5. The method of claim 1, further comprising collecting interaction data corresponding to a user's interaction with the at least one displayed advertisement.

6. The method of claim 5, wherein the interaction data is at least one of a user selection, a viewing time and an advertisement media type.

7. The method of claim 1, wherein the portable electronic device is a mobile phone.

8. A system of selecting and displaying interactive advertising content on a lock screen on a portable electronic device, comprising:
a portable electronic device having a processor and a memory comprising:
a user data collection unit stored on the memory and executable by the processor to collect a plurality of interaction data from the portable electronic device which corresponds to a user's interaction with the at least one displayed advertisement; and
an advertisement-selecting server which receives the user data and selects at least one advertisement based on the plurality of user data;
wherein the portable electronic device further comprises an advertisement display unit stored on the memory and executable by the processor to receive at least one selected advertisement and displays the at least one selected advertisement on a touch-sensitive display of the portable electronic device when a lock screen function on the portable electronic device is activated; and
wherein the lock screen includes a menu button which is configured to display options for interacting with the lock screen.

9. The system of claim 8, wherein the user data includes at least one of location data, search query data and social media data.

10-12. (canceled)

13. The system of claim 8, wherein the interaction data is at least one of a user selection, a viewing time and an advertisement media type.

14. The system of claim 8, wherein the portable electronic device is a mobile phone.

15. A method of selecting and displaying interactive advertising content on a splash screen on a portable electronic device, comprising:
transmitting a plurality of user data from a portable electronic device to an advertisement-selecting server;
selecting at least one interactive advertisement at the advertisement-generating server based on the plurality of user data;
transmitting the at least one selected interactive advertisement from the advertisement-generating server to the portable electronic device; and
displaying the at least one interactive advertisement on a touch-sensitive display screen of the portable electronic device when a splash screen function is activated;
wherein the splash screen includes a menu button which is configured to display options for interacting with the splash screen.

16. The method of claim 15, wherein the user data includes at least one of location data, search query data, social media data and keyword data.

17.-18. (canceled)

19. The method of claim 15, further comprising collecting interaction data corresponding to a user's interaction with the at least one displayed interactive advertisement.

20. The method of claim 15, wherein the splash screen is displayed after a user has selected an unlock function on a lock screen.

21. The method of claim 1, wherein the menu button displays an option for terminating the lock screen function.

22. The method of claim 1, wherein the menu button displays an option for interacting with the at least one advertisement.

23. The method of claim 1, wherein the lock screen further comprises an advertisement search window.

24. The method of claim 1, wherein a user can perform a gesture on the display screen to scroll to a new advertisement.

25. The system of claim 8, wherein the menu button displays an option for terminating the lock screen function.

22. The system of claim 8, wherein the menu button displays an option for interacting with the at least one advertisement.

23. The method of claim 15, wherein the menu button displays an option for terminating the lock screen function.

24. The method of claim 15, wherein the menu button displays an option for interacting with the at least one advertisement.
